(19) United States
(12) Patent Application Publication
(10) Pub. No.: US 2009/0275286 A1
(43) Pub. Date: Nov. 5, 2009

(54) UTILIZATION OF COGNITIVE RADIOS WITH MOBILE VIRTUAL PRIVATE NETWORK (MVPN) SOLUTIONS

(75) Inventors: George Popovich, Palatine, IL (US); Randy L. Ekl, Lake Zurich, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/112,543

(22) Filed: Apr. 30, 2008

(51) Int. Cl. H04Q 7/00

(52) U.S. Cl. 455/62

(57) ABSTRACT

A method (300, 350) and a mobile system (140) of persisting a mobile communication session over a mobile virtual private network (MVPN) (170). Cognitive radio state information (150) representing a present state of at least one available cognitive radio communication link (180, 182) can be processed to determine whether the cognitive radio communication link is a preferred communication link. An active radio communication link with which to communicate over the MVPN can be selected.

### BACKGROUND OF THE INVENTION

1. Field of the Invention

The present invention generally relates to RF communications and, more particularly, to allocation and utilization of RF channels.

2. Background of the Invention

Over the past few decades, the primary format in which multimedia content is stored and distributed has been shifting away from an analog format toward a digital format. One of the many advantages of digitally coding multimedia content is that compression methods can be applied to reduce the amount of storage space and bandwidth required for multimedia data storage and transmission. Thus, multimedia content can be digitally broadcast with higher quality (e.g. high definition) and using less bandwidth as compared to traditional analog broadcasts.

With these benefits in mind, the U.S. Congress has mandated that high power television broadcasters shift their broadcast signals from analog to digital by February 2009, which will free up RF spectrum between the digital channels, also known as white spaces, for other uses. There are many proposed uses for the white spaces, including fixed commercial applications, telecommunications, Internet access, peer-to-peer networking and for communications among low power electronic devices. The Federal Communications Commission has indicated that, for many of these uses, licenses may not be required. Without the use of licenses to control the number of RF transmissions, network congestion and disruption of communication signals due to RF interference may become more prevalent than today.

### BRIEF DESCRIPTION OF THE DRAWINGS

Preferred embodiments of the present invention will be described below in more detail, with reference to the accompanying drawings, in which:

FIG. 1 depicts a communication system that is useful for understanding the present invention;

FIG. 2 depicts a block diagram of a mobile virtual private network (MVPN)/cognitive radio device that is useful for understanding the present invention;

FIG. 3a is a flowchart presenting a method of persisting a mobile communication session over a MVPN that is useful for understanding the present invention; and

FIG. 3b is another flowchart presenting a method of persisting a mobile communication session over a MVPN that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Arrangements described herein relate to the selective use of cognitive radio to persist a mobile communication session over a mobile virtual private network (MVPN). As used herein, the term “persist” means to continue to maintain a particular state or action. For example, to persist the mobile communication session over the MVPN means to continue to maintain the mobile communication session over the MVPN, even as radio communication links that support the MVPN change.

Accordingly, decision making processes of cognitive radio, which will be described herein, can be combined with higher level intelligence at the network level, for example using a MVPN client, in order to select the best available communication resources for a given application. For example, a cognitive radio can determine that a greater amount of bandwidth is currently available over one or more white space spectrums in which incumbent or non-incumbent users are not presently transmitting, and a MVPN client or the cognitive radio can determine whether any of such radio communication links likely is the best communication option currently available. If at least one of the radio communication links currently is the best available option, the MVPN can be transferred to such radio communication link(s) while maintaining the communication session over the MVPN.

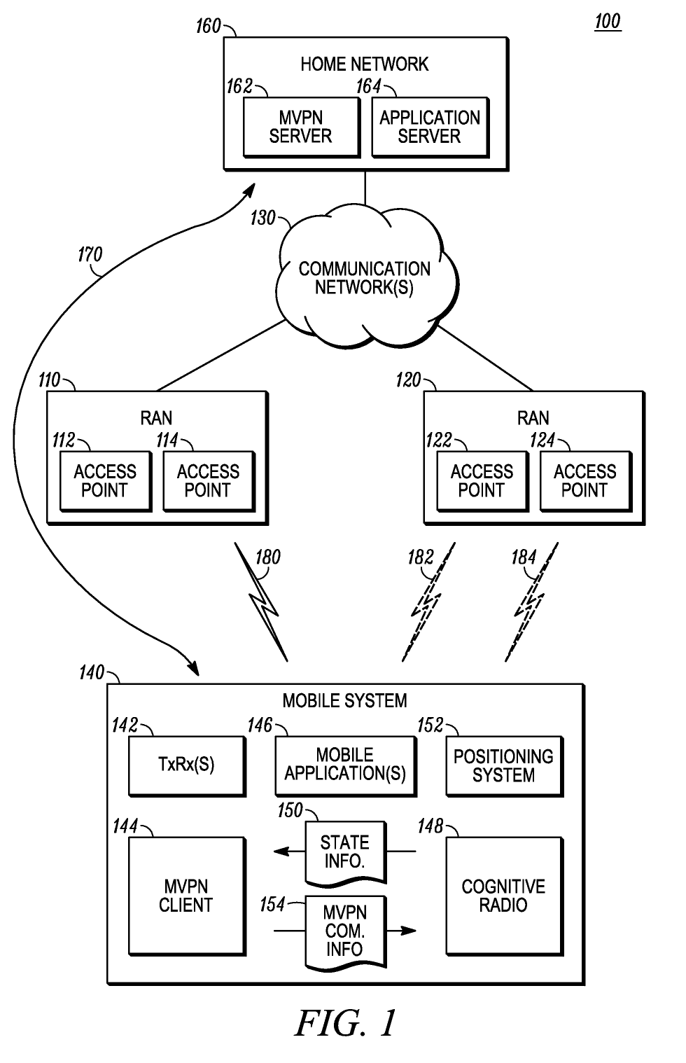

FIG. 1 depicts a communication system 100 that is useful for understanding the present invention. The communication system 100 can include one or more radio access networks 110, 120, each of which may comprise an interconnect communications network (e.g. a cellular communications network), a dispatch communications network, a metropolitan area network (MAN), a WiFi network, a Mesh network, a wireless local area network (WLAN) and/or any other networks or systems that support wireless communications. Moreover, the radio access networks 110, 120 can be configured to communicate data via IEEE 802 wireless communications, for example, 802.11 and 802.16 (WiMAX), 3G, 4G, EUTRAN, UMB, WPA, WPA2, GSM, TDMA, CDMA, WCDMA, OFDM, direct wireless communication, or any other communications format. Indeed, the radio access networks 110, 120 can be implemented in accordance with any suitable communications standards, protocols, and/or architectures, or a suitable combination of such standards, protocols, and/or architectures.

Each of the radio access networks 110, 120 may include one or more access points 112, 114, 122, 124. The access points 112, 114, 122, 124 can be, for example, base transceiver stations, repeaters, WLAN access points, or any other systems comprising equipment for wirelessly communicating with mobile communication systems, such as a mobile system 140. As such, each access point 112, 114, 122, 124 can comprise one or more antenna elements and one or more components for transmitting and receiving RF signals (e.g. transceivers). As known to those skilled in the art, the access points 112, 114, 122, 124 also may include any of a myriad of other suitable components, for instance network adapters, communication ports, controllers, and so on, but the invention is not limited in this regard.

In addition to the access points 112, 114, 122, 124, the radio access networks 110, 120 further can include access gateways, routers, switches, network servers, proxy servers, system controllers, and so on. Such components also are well known to the skilled artisan.

The radio access networks 110, 120 can be communicatively linked to one or more external communication networks 130. Examples of such communication networks 130 can include, but are not limited to, local area networks (LANs), wide area networks (WANs), such as the Internet, the World Wide Web and/or a public switched telephone network (PSTN), or the like.

The communication system 100 also may include a mobile system 140, one or more components of which can be carried in/on or otherwise attached to one or more mobile objects, for instance vehicles, cycles, aircraft, vessels, persons or the like. One or more transceivers 142 can be provided in the mobile system 140 and configured to communicate with the radio access networks 110, 120 via one or more of the respective access points 112, 114, 122, 124. As such, the transceiver(s) 142 also can communicate data via IEEE 802 wireless communications, for example, 802.11 and 802.16 (WiMAX), 3G, 4G, EUTRAN, UMB, WPA, WPA2, GSM, TDMA, CDMA, WCDMA, OFDM, direct wireless communication, or any other communications format.

The mobile system 140 further can include a MVPN client. As used herein, a MVPN client is a virtual private network (VPN) client that can maintain a MVPN 170 while handing off from one access point 112 to another access point 114 and/or while handing off from a first radio access network 110 to another radio access network 120 (e.g. by handing off from the access point 114 to the access point 122). By way of example, the MVPN client 144 can be a mobile IP client that implements data encryption in accordance with any of a myriad of suitable VPN data encryption technologies, examples of which include, but are not limited to, IP security (IPsec) and secure socket layer (SSL).

The MVPN client 144 can establish the MVPN 170 (e.g. a MVPN tunnel) with a MVPN server 162, or another suitable device, as will be described. In one arrangement, the MVPN server 162 can be located within a home network 160 of the MVPN client 144, though this need not be the case. For example, the MVPN server 162 also may be a component of the radio access network 110 or the radio access network 120. Using the MVPN 170, mobile applications 146 instantiated within the mobile system 140 can maintain a continuous communication session with an application server 164 that is linked to the MVPN server 162. This communication session can be maintained even as the mobile system 140 roams among radio access networks 110, 120 and as the communication protocols used by the mobile system 140 to communicate with the various access points 112, 114, 122, 124 changes.

The mobile applications 146 can be any applications that may communicate over the MVPN 170. For example, the mobile applications 146 can be those which are instantiated on the MVPN client 144 or on mobile processing devices communicatively linked to the MVPN client 144 via wired and/or wireless communication links (e.g. Bluetooth, ZigBee, infrared, etc.). Examples of such mobile processing devices can include, but are not limited to, mobile computers, mobile terminals, mobile telephones, mobile radios, personal digital assistants, application specific devices, or the like.

In addition to the MVPN client 144, the mobile system 140 also can include a cognitive radio 148. Both the MVPN client 144 and the cognitive radio 148 can be carried in/on or otherwise attached to a single mobile object, such as an emergency response vehicle. In such an arrangement, the MVPN client 144 and the cognitive radio 148 can be communicatively linked via a wired and/or wireless communication link. In another arrangement, the MVPN client 144 can be attached to a first mobile object while the cognitive radio 148 may be attached to a second mobile object and wirelessly linked to the MVPN client 144, for example using Bluetooth, ZigBee, WiFi, infrared, or the like.

As used herein, a cognitive radio is a radio that is capable of detecting (e.g. measuring, receiving, determining or otherwise identifying) at least one factor of an RF environment and, based at least in part on the detected factor, automatically generating cognitive radio state information 150 (hereinafter “state information 150”) which indicates the detected factor of the RF environment. In one arrangement, the detected factor(s) may only be factors that represent the state of cognitive radio communication links. As used herein, a cognitive radio communication link is a radio communication link between the cognitive radio 148 and an access point 112, 114, 122, 124 with which the cognitive radio 148 is configured to communicate, and which may be used by the cognitive radio 148 to establish and/or maintain network presence on the radio access network 110 and/or the radio access network 120. In another arrangement, the detected factor(s) also may include other information, such as location information, as will be described.

By way of example, the cognitive radio 148 can detect that a frequency band over which it is communicating with the access point 122 is becoming congested. Based on such detection, the cognitive radio 148 can generate state information 150 which indicates the congestion. The state information 150 also may indicate that one or more other resources that are currently available for use by the cognitive radio. Such resources can be, for example, available frequency bands, channels and/or a communication protocols. The other resources also can be access points 112, 114, 124 and/or radio access networks 110, 120 with which the cognitive radio 148 is configured to communicate via a radio communication link. Optionally, the state information 150 can include an indication of a suggested radio communication link 184 to be selected as the active radio communication link. For example, the state information 150 may provide an indication that the MVPN 170 should handoff to such other radio access network 120 and/or access point 124.

In another example, a factor of the RF environment detected by the cognitive radio 148 can be the present location of the mobile system 140, or a user of the mobile system 140/cogntive radio 148. For example, the mobile system 140 can include a positioning system 152, such as a global positioning system (GPS) or a local positioning system, and the cognitive radio 148 can receive location information from the positioning system 152. The location information can be provided to the cognitive radio 148 as geographic coordinates, relative coordinates to known points, city names, village names, area codes, zip codes, street names, addresses, or in any other suitable manner. In one arrangement, the location information also can indicate whether a user of the mobile system 140/cognitive radio 148 is located within a structure, for example based on the GPS coordinates (e.g. an altitude of 50 m at a location where the top of the building is 100 m), signal strength from a GPS satellite, signal strength received from an access point 112, 114, 122, 124, or in any other suitable manner.

In one aspect of the inventive arrangements, based on the location information, the cognitive radio 148 also can detect whether the mobile system 140/cognitive radio 148 is presently located in a geographic region in which an incumbent user has priority over a user of the cognitive radio 148 to transmit in a particular frequency band or on a particular channel within the frequency band. The cognitive radio 148 also can scan the frequency band to which the cognitive radio communication link is allocated and determine whether the incumbent user is transmitting RF signals in that frequency band. An incumbent user is a user who is licensed to operate in the frequency band. In contrast, a non-incumbent user, or secondary user, is a user who is not licensed to use the frequency band, but who may nonetheless use the band by following certain restrictions, for instance not interfering with the broadcast of an incumbent user. If there is broadcast activity by an incumbent user or a non-incumbent user, such broadcast activity can be detected and processed to create state information which can be reported.

Alternatively, the cognitive radio 148 and/or the positioning system 152 can communicate the location information to the MVPN client 144 and, if so configured, the MVPN client 144 can determine whether there is an incumbent user for the location, whether the incumbent user or another non-incumbent user is transmitting, whether the user of the cognitive radio 148 can begin transmitting as a non-incumbent user, etc.

To determine whether there is an incumbent user in a particular geographic region, the cognitive radio 148 and/or the MVPN client 144 can access one or more data tables or data files which identify incumbent users, the RF spectrums allocated to the incumbent users, the geographic regions for which the RF spectrums are allocated, maximum transmission levels for non-incumbent users in the geographic regions, and so on. Such data tables or data files can be contained in the mobile system 140, in the radio access network 110, in the radio access network 120, in the home network 160, or in any other location from which the information may be retrieved by the cognitive radio 148 or another component of the mobile system 140.

Other factors of the RF environment that may be detected by the cognitive radio 148 can include, but are not limited to, a quality of service (QoS), available bandwidth, a level of reliability, a latency associated with one or more of the access points 112, 114, 122, 124 or the radio access networks 110, 120, or any other factors that may be processed to select an active radio communication link over which to communicate. The cognitive radio 148 also can monitor broadcast activity (e.g the amount of bandwidth being consumed) by incumbent and/or non-incumbent users in a frequency band or on one or more specific channels used for a particular cognitive radio communication link. In one arrangement, such factors can be detected by monitoring beacons or advertisements generated by one or more of the radio access networks 110, 120 and/or the access points 112, 114, 122, 124, or by communicating messages to the radio access networks 110, 120 and/or the access points 112, 114, 122, 124 requesting the information.

In another arrangement, for example when the mobile system 140 has established network presence on a particular radio access network 110, 120 and/or the access point 112, 114, 122, 124, the cognitive radio can monitor RF signals transmitted and received by the mobile system 140 to detect the factors of the RF environment.

The cognitive radio 148 also can communicate the state information 150 indicating the detected factor(s) of the RF environment to the MVPN client 144. For this example, assume that the radio communication link 180 with the access point 114 and the radio communication link 182 with the access point 122 are cognitive radio communication links. The MVPN client 144 can process the state information 150 to determine whether either of the radio communication links 180, 182 are preferred communication links. As part of such determination, the MVPN client 144 can determine whether the detected factor(s) meet at least one criteria, such as a minimum QoS, available bandwidth, a minimum level of reliability, a maximum latency, whether there are incumbent and/or non-incumbent users currently transmitting in the same RF spectrum as either of the cognitive radio communication links 180, 182, and so on.

In one arrangement, if a user of the mobile system 140/cognitive radio 148 is presently located in a particular location in which an incumbent user has priority over the mobile system 140/cognitive radio 148 user, but there are no incumbent and/or non-incumbent users currently transmitting in the same RF spectrum as either of the cognitive radio communication links 180, 182, the MVPN client 144, or the cognitive radio 148 itself can automatically identify the cognitive radio 148 (or the user of the mobile system 140/cognitive radio 148) as a non-incumbent user for the RF spectrums. In addition, the cognitive radio 148 can transmit a signal, such as a beacon, to alert other potential users that the user of the cognitive radio 148 is a non-incumbent user. Alternatively, the identification of the cognitive radio 148 as a non-incumbent user can take place if and when a particular cognitive radio communication link 180, 182 is selected and/or the cognitive radio 148 begins transmitting on the selected cognitive radio communication link 180, 182.

In addition to the state information 150, the MVPN client 144 can evaluate other criteria of the MVPN to determine whether a particular cognitive radio communication link is a preferred communication link. For instance the MVPN client 144 also can process communication mode priorities, communication policies and communication requirements (e.g. support of particular communication protocols) of the MVPN 170 (hereinafter MVPN communication information 154) to determine whether to select a particular radio communication link 180 as the preferred communication link. If the selected radio communication link 180 is a cognitive radio communication link, the MVPN client 144 can direct the cognitive radio 148 to establish network presence on the radio access network 110 via the access point 114 to establish the cognitive radio communication link 180.

In this manner, the MVPN client 144 can selectively communicate via the cognitive radio 148. For example, the MVPN client 144 can select whether to communicate via the cognitive radio 148, when initially establishing the MVPN 170, when the RF environment of the communication system 100 changes, when the MVPN communication requirements, procedures and/or policies require a transfer from an existing radio communication link, or for any other desired reason. For example, under certain circumstances the MVPN client 144 may communicate over a radio communication link 184 established by the MVPN client 144 using the transceiver 142, without use of the cognitive radio 148, so long as there is adequate bandwidth and QoS to do so. In other circumstances, the MVPN client 144 may communicate over radio communication link 180 established by the cognitive radio 148 by default so long as there is adequate bandwidth and QoS to do so. Nonetheless, the invention is not limited in this regard.

Radio access network conditions and MVPN requirements may change from time to time. Thus, the MVPN client 144 also can monitor the state information 150 and MVPN communication information 154 to detect changes. When changes are detected, the state information 150 can be processed to determine whether a currently active cognitive radio communication link 180 still meets the criteria in which changes were identified. If, for instance, there are changes detected in the level of RF signals being broadcast on the same frequency spectrum being used for the cognitive radio communication link 180 (e.g. due to incumbent or non-incumbent users), such RF signal levels can be included in the state information 150. Due to the changes in the state information 150, or changes in the MVPN communication information 154, the cognitive radio communication link 182 may become the preferred communication link. Accordingly, the MVPN client 144 can select the radio communication link 182 as a preferred communication link to establish and/or maintain the MVPN 170.

The MVPN client 144 then can direct the cognitive radio 148 to establish network presence on the radio access network 120 via the access point 122 to establish the cognitive radio communication link 182, and the MVPN client 144 can initiate transfer (i.e. handoff) of the present communication session from the access point 114 to the access point 122, thereby selecting the radio communication link 182 as the new active communication link. Further, in response to selecting the radio communication link 182 as the new active communication link (e.g. the communication link with which to communicate over the MVPN 170), the MVPN client 144 can communicate a message to the MVPN server 162 to perform re-registration of the MVPN client 144 via the radio access network 120. The MVPN client 144 also can direct the cognitive radio 148 to terminate (or teardown) the cognitive radio communication link 180 with the radio access network 110.

The present arrangements are not limited to the use of cognitive radio communication links. Indeed, the MVPN client 144 can choose any other suitable radio access networks, access points and radio communication links with which to maintain the MVPN 170. Moreover, the MVPN client 144 can transfer among various radio access networks, access points and communication links as necessary to comply with MVPN communication information 154 as the RF environment changes and the communication mode priorities, communication policies and/or communication requirements of the MVPN 170 change.

For example, the criteria for one or more parameters of the MVPN 170 change at the behest of the MVPN client 144, the MVPN server 162, or another component of the communication system 100. For instance, criteria for a communication mode priority, a communication policy and/or a communication requirement may change. In response, a determination can be made whether the present radio communication link meets the criteria in which the change was detected (e.g. the new criteria). Such determination can be made regardless of whether the present communication link is a cognitive radio communication link or another type of radio communication link. If, for instance, the bandwidth requirements for the MVPN increase beyond that which is available using the cognitive radio 148, or network load balancing is to be implemented, the MVPN client 144 can initiate mobile access transfers as required.

In addition to the arrangements previously described in which much of the processing for selecting the radio access networks 110, 120, the access points 112, 114, 122, 124 and the radio communication links 180, 182, such processing also can be allocated to the cognitive radio 148. For instance, the cognitive radio 148 can receive the MVPN communication information 154 and process the MVPN communication information 154 along with the state information 150 (detected factors of the RF environment) to select the radio access networks 110, 120, the access points 112, 114, 122, 124 and the radio communication links 180, 182 that are used to maintain the MVPN 170, regardless of whether the radio communication links that are being selected are cognitive radio communication links.

Moreover, the cognitive radio 148 can direct the MVPN client 144 to communicate messages to the MVPN server 162 to perform registration and re-registration of the MVPN client 144 via the various radio access networks 110, 120, and enabling the MVPN client 144 to selectively communicate via the cognitive radio 148 (e.g. maintaining the MVPN with or without using the cognitive radio 148 in the communication signal path, etc.).

At this point it should be noted that although the cognitive radio 148 may have one or more of the transceivers 142 dedicated for its own use, in another arrangement one or more of the transceivers 142 can be shared by the cognitive radio 148 and other components of the mobile system 140. Moreover, the MVPN client 144 and the cognitive radio 148 can be combined into a single device that performs both the functions of the cognitive radio 148 and the functions of the MVPN client 144. Such device also can include a positioning system 152 and/or one or more transceivers 142.

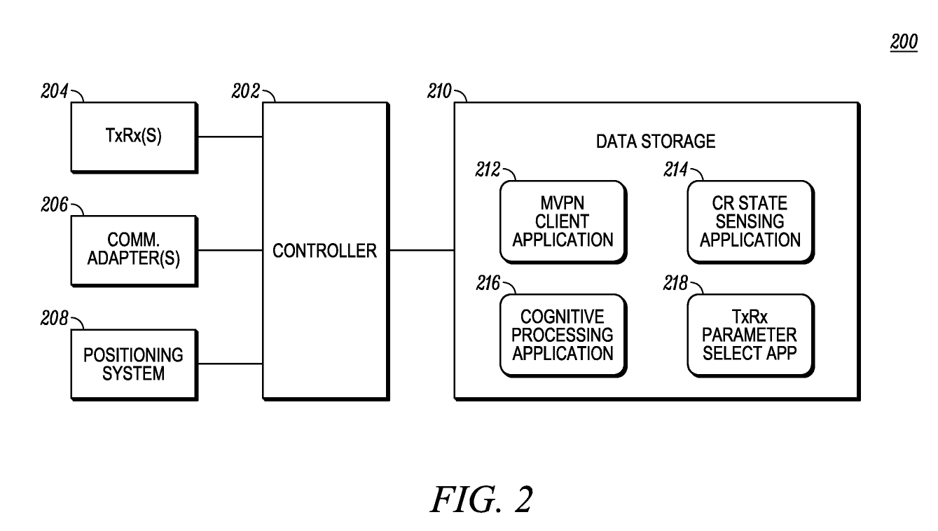

An example of a communication device 200 that performs both cognitive radio and MVPN functions is depicted in FIG. 2. The communication device 200 can include a controller 202, which may comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The communication device 200 also can include, or be coupled to, one or more transceivers 204. As noted, the transceiver(s) 204 also can communicate data via IEEE 802 wireless communications, for example, 802.11 and 802.16 (WiMAX), 3G, 4G, EUTRAN, UMB, WPA, WPA2, GSM, TDMA, CDMA, WCDMA, OFDM, direct wireless communication, or any other communications format. In one arrangement, one or more of the transceivers 204 can be software defined radios, which are known to the skilled artisan.

One or more communication adapters 206 also can be provided to support communication with one or more mobile processing devices. The communication adapters 206 can be wired and/or wireless. For example, a communication adapter 206 can include, but is not limited to, a network adapter, a communication port, a communication bus, a Bluetooth transceiver, a ZigBee transceiver, an infrared transceiver, or any other devices which may communicate with a mobile processing device (e.g. mobile computers, mobile terminals, mobile telephones, mobile radios, a personal digital assistants, application specific devices, or the like).

A positioning system 208 also can be provided with the communication device 200. The positioning system 208 can include a GPS receiver, a local positioning receiver, or any other device that can identify a geographic location. Such devices are known to the skilled artisan. In one arrangement, in addition to identifying a geographic location based on latitude, longitude and/or height, the positioning system 208 can indicate whether the communication device is located within a structure, such as a building.

The communication device 200 further can include a data storage 2 10. The data storage 210 can include one or more storage devices, each of which may include, but is not limited to, a magnetic storage medium, an electronic storage medium, an optical storage medium, a magneto-optical storage medium, and/or any other storage medium suitable for storing digital information. In one arrangement, the data storage 210 can be integrated into the controller 202, though this need not be the case.

A MVPN client application 212, cognitive radio state sensing application 214, cognitive processing application 216 and a transmit/receive parameter selection application 218 can be stored on the data storage 210 or otherwise made accessible to the controller 202. The MVPN client application 212 can be executed by the controller 202 to implement the methods and processes described herein that are performed by the MVPN client. For example, the controller 202 can execute the MVPN client application 212 to register with a MVPN server to establish a MVPN. The MVPN client application 212 also can be executed to re-register with the MVPN server, or update a MVPN routing table, when a new radio communication link is selected or established. The MVPN client application 212 also can be executed to generate and/or convey MVPN communication information for processing as described herein.

The cognitive radio state sensing application 214 can be executed by the controller 202 to implement cognitive radio state sensing as described herein. For example, the cognitive radio state sensing application 214 can detect cognitive radio state information, including information representing a present state of one or more available cognitive radio communication links. Such states can include factors of the RF environment of the communication links, such as QoS, available bandwidth, a level of reliability and latency.

The cognitive processing application can be executed by the controller 202 to select an active radio communication link with which to communicate over the MVPN based on the determination which radio communication link is a preferred communication link to persist a mobile communication session over a MVPN. For example, the controller 202 can execute the cognitive processing application 216 to process the cognitive radio state information generated by the cognitive radio state sensing application 214, MVPN communication information received from the MVPN client application 212, and location information generated by the positioning system 208. Based on such data, an appropriate radio communication link can be selected.

The transmit/receive parameter selection application 218 can be executed by the controller 202 to select transmit and/or receive parameters for the transceiver(s) 204 in order to establish network presence on an access point of a radio access network using the selected radio communication link and to support the MVPN over such communication link. The selection of the parameters can be based on the frequency band and modulation schemes of the selected radio communication link, the RF environmental conditions (e.g. a maximum amount of transmit power that may be used to prevent interference with an incumbent or other non-incumbent users transmitting in the same frequency band), network protocols, beam forming requirements, and so on. The controller 202 can communicate the selected transmit and/or receive parameters to one or more of the transceivers 204 to establish the selected radio communication link which, as noted, can be a cognitive radio communication link.

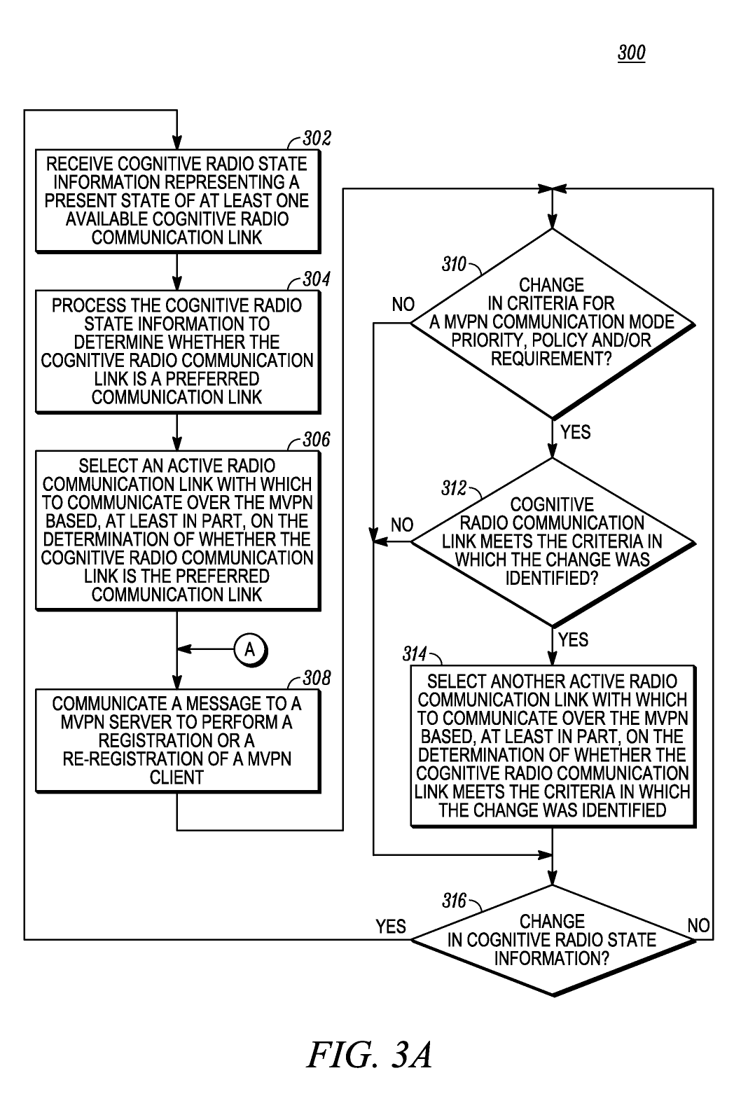

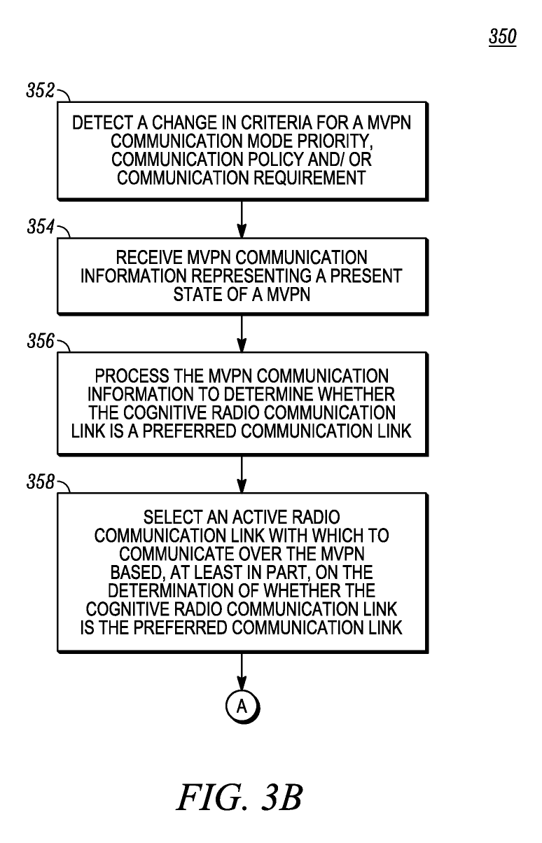

FIG. 3a is a flowchart presenting a method 300 of persisting a mobile communication session over a MVPN that is useful for understanding the present invention. The method 300 can begin in a state in which a MVPN client of a mobile system has initiated registration of a MVPN with a MVPN server, for instance in response to initiating entry onto a radio access network or in response to an application request. Beginning at step 302, cognitive radio state information representing a present state of at least one available cognitive radio communication link can be received, for example by the cognitive radio or by a MVPN client.

At step 304, the cognitive radio state information can be processed to determine whether the cognitive radio communication link is a preferred communication link. For example, a determination can be made whether the cognitive radio communication link meets a minimum QoS, an available bandwidth, a minimum level of reliability and/or a maximum latency. In another arrangement, a determination can be made whether one or more parameters of the cognitive radio communication link meets one or more criteria of the MVPN, for instance a communication mode priority, a communication policy and/or a communication requirement.

In yet another arrangement, a determination can be made whether a user in the mobile communication session is a non-incumbent user of the cognitive radio communication link. A present location of the user also can be determined. Further, a frequency band to which the cognitive radio communication link is allocated can be scanned. When there is no broadcast activity by an incumbent user or another non-incumbent user, the user can be identified as a non-incumbent user.

At step 306 an active radio communication link with which to communicate over the MVPN can be selected based, at least in part, on the determination of whether the cognitive radio communication link is the preferred communication link. At step 308, a message can be communicated to a MVPN server to perform a registration or a re-registration of a MVPN client. For example, if the MVPN is being established, the MVPN server can be asked to perform a MVPN registration. If, however, the MVPN is being transferred from a first radio communication link to a second radio communication link, the MVPN server can be asked to perform a MVPN re-registration to maintain the MVPN over the new radio communication link.

In an alternative arrangement, if the MVPN is being transferred from a first radio communication link to a second radio communication link, rather than performing a MVPN re-registration, MVPN routing preferences can be changed. For example, a routing table for the MVPN can be updated to indicate the newly selected active radio communication link. Moreover, the MVPN client may remain registered over multiple radio communication links, even though a particular radio communication link may be selected as the radio communication link that is currently active for the MVPN.

Proceeding to decision box 310, a change in criteria for a MVPN communication mode priority, communication policy and/or communication requirement can be detected. Referring to decision box 312, a determination can be made whether the cognitive radio communication link meets the criteria in which the change was identified. If so, the process can proceed to step 314 and another active radio communication link with which to communicate over the MVPN can be selected based, at least in part, on the determination of whether the cognitive radio communication link meets the criteria in which the change was identified. Continuing to decision box 316, if a change in cognitive radio state information is detected, the process can return to step 302. The process then can proceed until the MVPN is released.

FIG. 3b is another flowchart presenting a method 350 of persisting a mobile communication session over a MVPN that is useful for understanding the present invention. The method 350 can begin in a state in which a MVPN has been established between the MVPN client of the mobile system and the MVPN server, for instance in accordance with the method 300 of FIG. 3a. At step 352 a change in a MVPN communication mode priority, a MVPN communication policy and/or a MVPN communication requirement can be detected. At step 354, MVPN communication information representing a present state of a MVPN can be received.

Proceeding to step 356, the MVPN communication information can be processed to determine whether the cognitive radio communication link is a preferred communication link. For example, a determination can be made whether the MVPN parameter meets the at least one criteria of the MVPN, such as a communication mode priority, a communication policy and/or a communication requirement. In another example, a determination can be made whether the cognitive radio communication link meets a minimum QoS, an available bandwidth, a minimum level of reliability and/or a maximum latency.

At step 358, an active radio communication link with which to communicate over the MVPN can be selected based, at least in part, on the determination of whether the cognitive radio communication link is the preferred communication link. The process then can proceed to step 308 of FIG. 3a and continue until the MVPN is released.

The arrangements described herein provide for the selective use of a cognitive radio to persist a mobile communication session over a MVPN, thereby enabling the decision making processes of cognitive radio to be combined with higher level network intelligence, for example using a MVPN client. Moreover, the present arrangements provide for support of a MVPN over a cognitive radio communication link, as well as other communication links that may be available. Thus, the best available communication resource for supporting a MVPN for a given application can be selected for use, even as network and RF environment conditions change.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof. Accordingly, reference should be made to the following claims, rather than to the foregoing specification, as indicating the scope of the invention.

What is claimed is:

1. A method of persisting a mobile communication session over a mobile virtual private network (MVPN), comprising:
receiving cognitive radio state information representing a present state of at least one cognitive radio communication link that is available;
processing the cognitive radio state information to determine whether the cognitive radio communication link is a preferred communication link; and
selecting an active radio communication link with which to communicate over the MVPN based, at least in part, on the determination of whether the cognitive radio communication link is the preferred communication link.

2. The method of claim 1, wherein processing the cognitive radio state information to determine whether the cognitive radio communication link is a preferred communication link comprises:
determining whether the cognitive radio communication link meets at least one criteria selected from a group consisting of a minimum quality of service, an available bandwidth, a minimum level of reliability and a maximum latency.

3. The method of claim 1, wherein processing the cognitive radio state information to determine whether the cognitive radio communication link is a preferred communication link comprises:
determining whether the cognitive radio communication link meets at least one criteria of the MVPN selected from a group consisting of a communication mode priority, a communication policy and a communication requirement.

4. The method of claim 1, wherein processing the cognitive radio state information to determine whether the cognitive radio communication link is a preferred communication link comprises:
determining whether a user in the mobile communication session is a non-incumbent user of the cognitive radio communication link.

5. The method of claim 4, wherein determining whether a user in the mobile communication session is a non-incumbent user of the cognitive radio communication link comprises:
determining a present location of the user.

6. The method of claim 4, wherein processing the cognitive radio state information to determine whether the cognitive radio communication link is a preferred communication link further comprises:
scanning a frequency band to which the cognitive radio communication link is allocated; and
when there is no broadcast activity by an incumbent user or another non-incumbent user, identifying the user as a non-incumbent user.

7. The method of claim 1, further comprising:
responsive to selecting the active radio communication link with which to communicate over the MVPN, communicating a message to a MVPN server to perform a registration or a re-registration of a MVPN client.

8. The method of claim 1, further comprising:
detecting a change in at least one criteria of a MVPN parameter selected from a group consisting of a communication mode priority, a communication policy and a communication requirement;
determining whether the cognitive radio communication link meets the criteria in which the change was detected; and
selecting another active radio communication link with which to communicate over the MVPN based, at least in part, on the determination of whether the cognitive radio communication link meets the criteria in which the change was identified.

9. A method of persisting a mobile communication session over a mobile virtual private network (MVPN), comprising:
receiving MVPN communication information representing a present state of a MVPN;
processing the MVPN communication information to determine whether a cognitive radio communication link is a preferred communication link for the MVPN; and
selecting the cognitive radio communication link as an active communication link for the MVPN based, at least in part, on the determination of whether the cognitive radio communication link is the preferred communication link.

10. The method of claim 9, wherein processing the MVPN communication information to determine whether the cognitive radio communication link is a preferred communication link for the MVPN comprises:
determining whether at least one MVPN parameter meets at least one criteria of the MVPN selected from a group consisting of a communication mode priority, a communication policy and a communication requirement.

11. The method of claim 9, wherein processing the MVPN communication information to determine whether the cognitive radio communication link is a preferred communication link for the MVPN comprises:
determining whether the cognitive radio communication link meets at least one criteria selected from a group consisting of a minimum quality of service, an available bandwidth, a minimum level of reliability and a maximum latency.

12. The method of claim 9, further comprising:
detecting a change in at least one criteria of the MVPN selected from a group consisting of a communication mode priority, a communication policy and a communication requirement; and
determining whether the cognitive radio communication link meets the criteria in which the change was identified.

13. The method of claim 9, further comprising:
responsive to selecting the active radio communication link with which to communicate over the MVPN, communicating a message to a MVPN server to perform a registration or a re-registration of a MVPN client.

14. A mobile system that persists a mobile communication session over a mobile virtual private network (MVPN), comprising:
a cognitive radio that detects at least one factor of an RF environment and, based at least in part on the detected factor, generates cognitive radio state information representing a present state of at least a first available cognitive radio communication link; and
a MVPN client that processes the cognitive radio state information to determine whether the first cognitive radio communication link is a preferred communication link and selects an active radio communication link with which to communicate over the MVPN based, at least in part, on the determination of whether the first cognitive radio communication link is the preferred communication link.

15. The mobile system of claim 14, wherein the state information generated by the cognitive radio further comprises:
a present state of at least a second cognitive radio communication link; and
an indication of whether the first available radio communication link or the second available radio communication link should be selected as the active radio communication link.

16. The mobile system of claim 14, wherein the MVPN client or the cognitive radio determines whether the cognitive radio communication link meets at least one criteria selected from a group consisting of a minimum quality of service, an available bandwidth, a minimum level of reliability and a maximum latency.

17. The mobile system of claim 14, wherein the MVPN client or the cognitive radio determines whether the cognitive radio communication link meets at least one criteria of the MVPN selected from a group consisting of a communication mode priority, a communication policy and a communication requirement.

18. The mobile system of claim 14, wherein the MVPN client or the cognitive radio determines whether a user in the mobile communication session is a non-incumbent user of the cognitive radio communication link.

19. The mobile system of claim 18, further comprising:
a positioning system that determines a present location of the user.

20. The mobile system of claim 14, wherein the MVPN client and the cognitive radio are included in a device that performs both MVPN client and cognitive radio functions.
